(19) United States
(12) Patent Application Publication
(10) Pub. No.: US 2009/0263620 A1
(43) Pub. Date: Oct. 22, 2009

(54) COMPOSITE BOARD WITH OPEN HONEYCOMB STRUCTURE

(76) Inventors: Garry E. Balthes, Lowell, MI (US); Mark J. Maatman, Clarksville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/425,208

(22) Filed: Apr. 16, 2009

Related U.S. Application Data
(60) Provisional application No. 61/045,467, filed on Apr. 16, 2008.

(51) Int. Cl. B32B 3/12

(52) U.S. Cl. 428/116

(57) ABSTRACT

A reinforcing core structure for a composite panel includes a body having a plurality of generally parallel, alternating ridges and grooves, in which walls extending between the ridges and grooves have a corrugated surface. The resulting core structure has an open honeycomb geometry that may be employed in various applications to provide a composite panel exhibiting an exceptional strength to weight ratio. In accordance with certain preferred embodiments, the panels may comprise reinforcing core structures fabricated from fibrous bodies containing a binder material to provide inexpensive structural members exhibiting excellent mechanical properties.

### CROSS-REFERENCE TO RELATED APPLICATION

This application claims priority under 35 U.S.C. § 119(e) on U.S. Provisional Application No. 61/045,467 entitled COMPOSITE BOARD WITH OPEN HONEYCOMB STRUCTURE, filed Apr. 16, 2008, the entire disclosure of which is incorporated herein by reference.

### FIELD OF THE INVENTION

This invention relates to a composite panel that exhibits an exceptionally high strength to weight ratio, and more particularly to the use of at least one corrugated reinforcing layer in a composite panel.

### BACKGROUND OF THE INVENTION

Many different types of multiple layer panel or board structures having at least one corrugated or honeycombed layer that imparts strength and rigidity to the composite structure are known. Such composite boards or panels have been employed in various automotive, building, and furniture applications. Generally, in such known structures, the corrugation or honeycomb layer is bonded to a flat, sheet-like layer or disposed between and bonded to two flat sheet-like layers. Although such structures have proven adequate for many applications, improved fibrous composite panels are desired.

### SUMMARY OF THE INVENTION

The invention responds to the desire for improved composite panels by providing a reinforcing core structure having a plurality of generally parallel, alternating ridges and grooves, wherein each of the plurality of ridges is defined by opposite sidewalls having a corrugated surface.

In accordance with various aspects of the invention, the reinforcing core structure is joined with other layers to form a composite panel or board exhibiting an exceptional strength to weight ratio.

These and other features, advantages and objects of the present invention will be further understood and appreciated by those skilled in the art by reference to the following specification and drawings.

### BRIEF DESCRIPTION OF THE DRAWINGS

FIG. 1 is a top plan view of a fibrous reinforcing core structure in accordance with various aspects of the invention.

FIG. 2 is a side view of a composite panel in accordance with the invention employing a fibrous reinforcing core structure located between and joined to flat sheet material layers.

FIG. 3 is a partial assembly perspective of a composite panel having finished edges in accordance with various aspects of the invention.

FIG. 4 is an expanded, fragmentary top view showing details of the fibrous reinforcing core structure shown in FIG. 1.

FIG. 5 is an expanded, fragmentary side view showing details of the composite panel shown in FIG. 2.

### DETAILED DESCRIPTION OF PREFERRED EMBODIMENTS

The various aspects of the invention disclosed herein relate to a reinforcing core structure having a plurality of generally parallel, alternating ridges and grooves, wherein walls of each of the plurality of ridges have a corrugated surface, composite panels incorporating the reinforcing core structure, and methods of making and using the fibrous reinforcing core structure and composite panels.

As used herein, the expression “reinforcing core structure” refers to a corrugated sheet of material. The sheet materials used to make the reinforcing core structures of the invention described herein are preferably comprised of fibers that are combined into a cohesive or unitized mat. The fibrous bodies or mats used for making fibrous reinforcing core structures may contain non-fibrous materials or additives dispersed on or between the fibers of which they are comprised.

The terms “fibrous” and “fibrous body” refer to materials comprised of fibers and to bodies of fibers, respectively. The term “fiber” is intended to have its ordinary meaning, and refers generally to materials having a length that greatly exceeds its other dimensions perpendicular to its length (e.g., width and thickness, or diameter).

The term “composite panel” refers to a panel having a plurality of layers that are separately formed and subsequently joined together. Generally, composite panels in accordance with the invention comprise a fibrous reinforcing core structure located between and joined to other layers, such as between non-corrugated (e.g., flat) sheets.

The expression “generally parallel ridges and grooves” refers to alternating ridges and grooves that may not be perfectly parallel to one another, but which do not merge or intersect along the length of the ridges and grooves.

As used herein the term “corrugated surface,” refers to a surface defining alternating ridges and grooves. The fibrous reinforcing core structures of the invention described herein differ from conventional corrugated and/or honeycomb-type reinforcing structures by having a corrugated sheet in which the ridges have sidewalls that are themselves corrugated. The resulting reinforcing core structures may be viewed as comprising corrugated corrugations. In effect, the reinforcing core structures of the invention have different corrugations in different, approximately orthogonal planes that can provide an improved strength to weight ratio.

Sheets that are not corrugated (e.g., flat sheets) may be joined to the reinforcing core structure to make composite panels in accordance with the invention described herein. Such sheets may be flat sheets of substantially uniform thickness (i.e., sheets having random thickness variations that are generally deemed acceptable or tolerable for an intended purpose, but not having any deliberately provided or predetermined thickness variations), a textured sheet of material having a decorative or functional relief pattern, or a three-dimensionally shaped sheet of material, provided that the “non-corrugated sheets” are not shaped to have alternating, generally parallel ridges and grooves.

The term “non-binder fibers” is used herein to refer to various fibers, including natural fibers, synthetic fibers, glass fibers, carbon fibers, and metal fibers, that do not melt during a thermoforming and/or shaping process used to prepare the core structure and/or other layers of a composite structure, and, therefore, do not act as binders in the completed fibrous layers and composites.

The term “non-binder additive” refers to non-fiber additives that do not melt or cross link (i.e., cure or become thermoset) during a thermoforming and/or shaping process used to prepare the core and/or other layers of a composite, and, therefore, do not act as binders in the completed fibrous layers and composites.

In accordance with certain embodiments of the invention, a composite panel comprising a plurality of layers, including a plurality of reinforcing core structure layers may be provided, wherein the reinforcing core structure layers are joined directly to each other or separated from each other by one or more intervening layers. Within such composite panels having at least two reinforcing core structures that each have alternating, parallel ridges and grooves, the alternating, parallel ridges and grooves of one of the reinforcing core structure layers may be arranged at an angle with respect to the generally parallel, alternating ridges and grooves of another reinforcing core structure layer (e.g., such as at approximately a right angle). Also, when two or more reinforcing core structure layers are employed in the same composite panel, the layers may be arranged with the generally parallel, alternating ridges and grooves substantially parallel to one another, but arranged in a staggered relationship, wherein, for example, the ridges of one of the fibrous reinforcing core structures overlies the grooves of an underlying fibrous reinforcing core structure, and wherein the layers may be either joined directly to one another, or joined together in a composite panel having at least one intervening layer.

In accordance with generally any of the composite panel embodiments of the invention, an improved strength to weight ratio is achieved by joining each of the opposite sides of each of the reinforcing core structures with at least one other layer of material. In accordance with these aspects of the invention, the reinforcing core structure combined with additional layers provides a composite structure that has exceptionally high load bearing capabilities, but is light in weight.

The principles of this invention may be employed for making generally flat or three-dimensionally shaped composite articles having a very high strength to weight ratio. Three-dimensional shaped composite articles may include articles having curvature about an axis (e.g., articles having a cylindrical section), articles having curvature about a point (e.g., articles having a spherical section), as well as articles having complex curvature (e.g., curvature around one or more points and/or one or more axes). In each of these embodiments, it is generally preferred that each of the layers of the composite is separately formed and subsequently jointed together to form a unitized composite structure. Alternatively, it is possible, in limited applications, to separately form the layers and join them together into a substantially flat composite structure that may be subsequently subjected to a shaping operation.

In accordance with certain preferred aspects of the invention, the reinforcing core structure may be comprised of generally any combination of synthetic fibers, natural fibers, glass fibers, carbon fibers and/or metal fibers. The fibers may be randomly or preferentially oriented into a non-woven unitized body or sheet of material that is held together by physical entanglement of the fibers. In order to impart thermoformability (i.e., the ability to shape a material under application of heat and thereafter retain the shape after cooling), the fibrous body may incorporate a thermosettable or thermoplastic resin binder material. The binder material may be dispersed within the fibrous body in the form of a solid particulate or powder, as a liquid, or as a fiber component.

Non-limiting examples of natural fibers that may be used include kenaf, hemp, jute, tossa, curaua and rayon fibers. Non-limiting examples of synthetic fibers that may be used include polyester, polyethylene, nylon and polypropylene. Bi-component synthetic fibers comprising two different polymeric materials having different melting temperatures (e.g., core-sheath bi-component fibers) may be employed. Non-fiber binding materials that may be employed include polypropylene, polyethylene, polyurethane, polyesters, vinyl acetates, acrylic polymers, acetates, melamine, and epoxy resins, such as epoxy polyester resins.

Generally, a wide variety of different fibers, fiber blends, with or without additional additives, may be employed. The selection of specific materials is not an essential feature of the broader aspects of the invention. However, in accordance with a preferred embodiment, a fibrous body used to prepare the fibrous reinforcing core structure of the invention is comprised primarily of a blend of natural fiber; a binder material; optional synthetic non-binder fibers, metal fibers, glass fibers, and/or carbon fibers; and optional non-fiber, non-binder additives. Preferably, the amount of binder material is at or near the minimum level needed to achieve desired thermoformability and shape-retention properties. Binder materials that may be employed include non-fiber thermosettable materials, non-fiber thermoplastic materials (e.g., so-called “hot-melt adhesives,” such as in a powdered form), and thermoplastic binder fibers (e.g., bicomponent fibers having a structural component with a first, relatively higher melting temperature, and a binder component with a second, relatively lower melting temperature).

When thermosettable binders are employed, the reinforcing core structure may be prepared from a fibrous body comprised of a single natural fiber, a combination of natural fibers, or a blend of non-binder fibers (i.e., fibers that do not melt during thermoforming and/or shaping processes, and do not act as binders in the completed structure), and a thermosettable resin that is present in an amount of from about 10% to about 40%, and more preferably from about 20% to about 30%, of the weight of the non-binder fibers. An example of suitable blend of non-binder fibers for use in a reinforcing core structure prepared using thermosettable binders comprises about 50% to 100% natural fiber(s) and up to 50% synthetic fiber(s) (e.g., polyester fibers, such as 15 denier recycled polyester fibers).

When thermoplastic binders are employed, the reinforcing core structure may be comprised of non-binder fiber(s) selected from glass fibers, carbon fibers, natural fibers, and synthetic fibers; and a thermoplastic binder that may be either a fiber or a non-fiber. A suitable proportion of natural fiber(s) as a percentage of the total weight of all fibers used in preparing the reinforcing core structure is from about 30% to about 70%, with the balance being fibers selected from the glass fibers, carbon fibers and synthetic fibers (either binder fibers or non-binder fibers). Binder fibers (e.g., polypropylene fibers) may be employed in an amount of from about 30% to 70% of the total weight of all fibers. Alternatively, non-fiber thermoplastic binders may be employed (e.g., in a powdered form) in an amount of from about 10% to 50% of the weight of the fibers.

The fibrous body used to prepare the reinforcing core structure may also contain relatively minor amounts of non-fiber additives, such as water-repellant agents, flame-resistant agents, and/or coloring agents.

The fibrous body or sheet can be shaped in a molding tool under application of heat and pressure to form a fibrous reinforcing core structure having suitable shape retention properties and strength, and having the desired alternating ridges and grooves with walls of the ridges having a corrugated surface (i.e., an open honeycomb structure). Such thermoforming tools and techniques are well known in the art, and are not described in detail herein.

While not intending to be bound by any particular theory, it is the belief of the inventors that honeycomb structures generally provide better reinforcing and strength properties to composite structures than corrugated reinforcing elements. However, honeycomb structures are difficult and expensive to make. The invention provides a fibrous reinforcing core structure having structural advantages similar to honeycomb reinforcing structures, while sharing a simplicity of manufacturing and lower cost similar to conventional corrugated reinforcing structures. The novel reinforcing structures of the invention have what may be described as corrugated corrugations or an “open honeycomb structure.” However, the invention represents a substantial departure from conventional honeycomb structures and conventional corrugated structures, and provides one or more benefits or a combination of benefits that cannot be achieved using conventional honeycomb reinforcing structures or conventional corrugated reinforcing structures.

The inventors further believe that by using a low mass corrugated reinforcing structure between layers of a composite panel, wherein the ridges of the corrugations have walls that are themselves corrugated, an optimum, or at least highly preferred, combination of strength, low cost, and lightweight is achieved.

In a particular embodiment of the invention, a fibrous reinforcing core structure is prepared by shaping a fibrous body comprised of fibers and thermosettable resin. The fibrous reinforcing core structure is preferably comprised of non-binder fibers selected from glass fibers, carbon fibers, natural fibers, and synthetic fibers; and a thermosettable resin that is present in an amount equal to from about 10% to 40% of the weight of the non-binder fibers.

In another embodiment, the fibrous reinforcing core structure may be made of a shaped fibrous body comprised of from about 40% to about 60% thermoplastic resin by weight dispersed among fibers selected from carbon fibers, glass fibers, natural fibers and synthetic fibers and combinations thereof, which fibers are present in the fibrous body in an amount of from about 40% by weight to about 60% by weight.

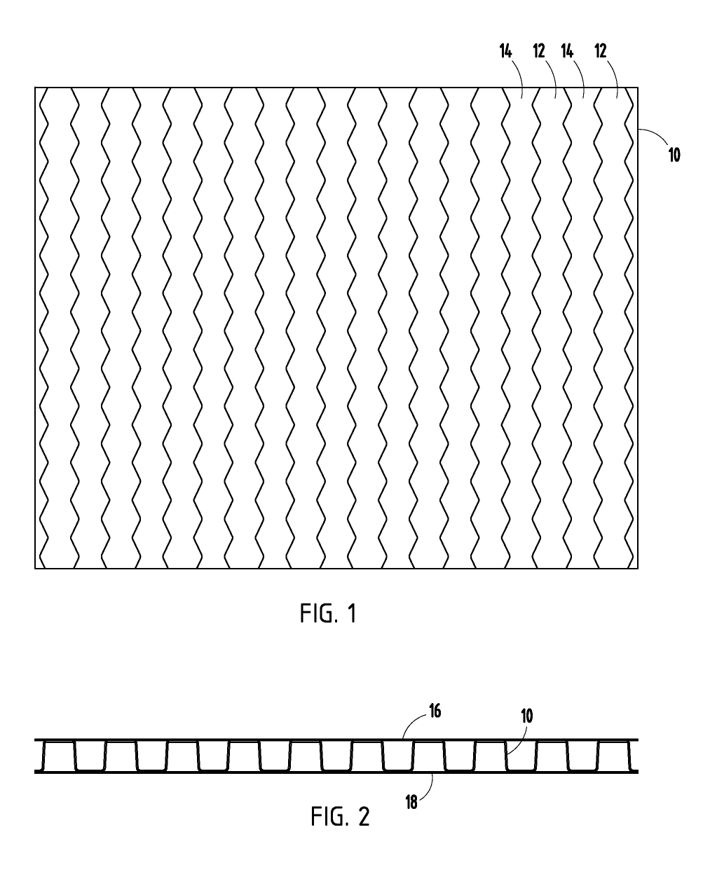

Shown in FIG. 1 is a fibrous reinforcing core structure 10 in accordance with the invention. The fibrous reinforcing core structure 10 includes a plurality of generally parallel alternating ribs 12 and grooves 14. It is to be understood that in the illustrated embodiment, grooves 12 and ribs 14 are a matter of perspective; grooves 12 in the top plan view of FIG. 1 define grooves in the bottom view of the same article. As shown in FIG. 2, a flat composite panel can be prepared by joining upper surfaces of fibrous reinforcing core structure 10 to an additional layer 16, and joining bottom surfaces of shaped fibrous body 10 to a bottom layer 18.

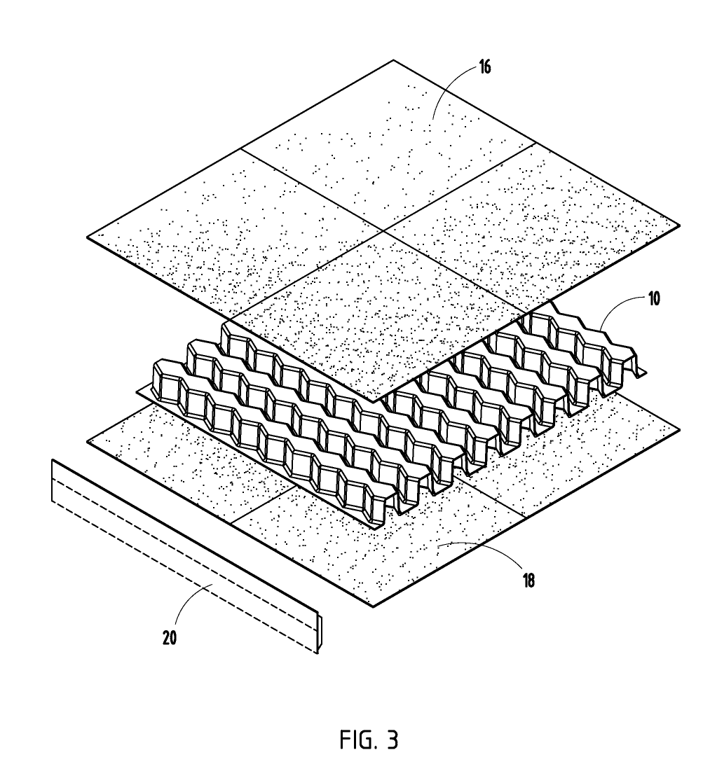

Various useful articles, such as desktops, tabletops, or other work surfaces or the like, can be prepared as illustrated in FIG. 3 by joining fibrous reinforcing core structure 10 to top and bottom layers 16 and 18 respectively, and completing the structure with an edge detail 20 which extends between the upper edges of layers 16 and 18 to conceal and completely encase fibrous reinforcing core structure 10. In the illustrated embodiment, only a single edge detail 20 is shown on one side, it being understood that similar elements may be attached along the remaining three edges.

In accordance with preferred embodiments of the invention, layers 16 and 18 are joined to fibrous reinforcing core structure 10 with an adhesive or by a thermofusion joint or weld achieved by fusing and solidifying thermoplastic materials (e.g., such as by using an ultrasonic welding technique) in the fibrous reinforcing core structure 10 with thermoplastic material in each of the layers 16 and 18. Adhesion and/or thermofusion techniques can be utilized to provide a connection or joint between fibrous reinforcing core structure 10 and layers 16 and 18 that is stronger than each of the individual layers of the composite, such that testing to failure will result in a failure of one of the component layers, rather than the bond between the layers.

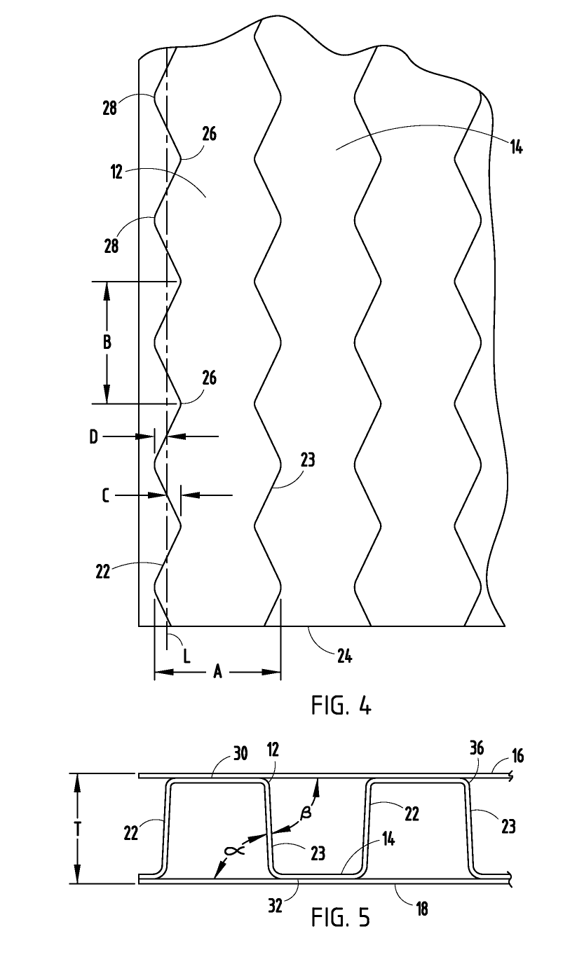

As shown in FIG. 4, the undulations or corrugations defined in sidewalls 22 of ridges 12 have a uniform periodicity with the maxima and minima of the undulations of opposite walls 22 of ridges 12 and of adjacent walls of adjacent ridges being located at equal distances from an edge 24 along the longitudinal direction of the ridges 12. Such symmetry and uniformity may not be required, but is preferred to simplify manufacturing and tool design, and to achieve substantially uniform strength properties. Similarly, to simplify manufacturing processes and tools, and to provide uniform strength properties, it is desirable, but not necessary, that the distance (e.g., from centerline to centerline) of adjacent ridges is equal to the distance (e.g., from centerline to centerline) from one groove to the next.

The undulations or corrugations in walls 22 may be defined in terms of a negative offset C (the distance between line L and a minima 26) and a positive offset D (the distance from line L to a maxima 28), a wavelength B (e.g., the distance from one minima 26 to an adjacent minima 26 of a wall 22). Ridges 12 may be further characterized in terms of a maximum width A (the distance between maxima 26 on opposite walls 22 and 23 of ridges 12), and thickness T (the vertical distance between the upper or outer surface of the top 30 of ridge 12 and the outer or bottom surface of the bottom 32 of groove 14, shown in FIG. 5). Suitable dimensions for ridges 12 of a fibrous reinforcing core structure used in a composite panel for a furniture or automotive application include offsets C and D each being about 2.5 millimeters with a variability or tolerance of about 0.1 millimeters, wavelength B being about 25 millimeters with a variance or tolerance of about 1 millimeter, maximum width A being about 22.6 millimeters with a variance of about 1 millimeter, and thickness T being about 20.6 millimeters with a variance of about 1 millimeter.

In order to facilitate high speed, mass production of the fibrous reinforcing core structures using conventional tooling while providing highly desirable strength properties, the angle alpha measured from bottom layer 18 to wall 23 is approximately 85 degrees. Similarly, the angle beta measured from top layer 16 to wall 23 is preferably about 85 degrees. Likewise, similar angles measured from layers 16 and 18 to wall 22 are preferably about 85 degrees.

In the illustrated embodiment shown in FIGS. 4 and 5, which is suitable for various automotive, furniture and building applications, the radius of curvature at the minima 26 and maxima 28 is about 4 millimeters with a suitable variance or tolerance being about 0.16 millimeters, the outer radius of curvature at the juncture 36 between ridge tops 30 and walls 22 and 23 is about 3 millimeters with a variance of about 0.12 millimeters, and the thickness of the compressed web of material forming fibrous reinforcing core structure 10 is about 1.2 millimeter.

The above dimensions are exemplary of a preferred embodiment, and suitable results can be achieved using different dimensions. For example, automotive load floors may require less thickness and could therefore be constructed using the same configuration illustrated in FIGS. 4 and 5, but using a cell height or thickness T that is less than the thickness (20.6 millimeters) previously described.

Layers 16 and 18 may be comprised of the same material used for making reinforcing core structure 10 or from different material that may be suitably joined to the reinforcing core structure. However, to achieve a relatively high strength to weight ratio, layers 16 and 18 are preferably comprised of or formed from fibrous bodies similar to those used for making the preferred fibrous reinforcing core structures. For example, layers 16 and 18 may be comprised of a combination of carbon fibers, glass fibers, synthetic fibers and natural fibers, with a preferred fiber blend comprising about 85% to 100% natural fiber(s) by weight, the balance of fibers, if any, being selected from synthetic fibers, glass fibers, carbon fibers, and metal fibers, and a thermosettable binding resin in an amount up to about 40% of the weight of the fiber(s).

Upper and lower layers 16 and 18 could be made from a fibrous body consisting of about 100% natural fiber(s) impregnated with a thermosettable resin in an amount up to 40% of the weight of the fiber(s), with the resulting fibrous body having a basis weight of about 1200 grams per square meter (gsm). These typical layers 16 and 18 may be used with a fibrous reinforcing core structure 10 having a basis weight of about 1200 gsm, although higher or lower basis weights may be employed (e.g., about 1000 to 1500 gsm), after being shaped into the final structure having generally parallel alternating ridges and grooves. Applications requiring additional stiffness may successfully employ embodiments of the invention using thicker layers 16 and/or 18, thicker fibrous reinforcing core structure 12, different dimensions (e.g., A, B, C, D and T) than in the illustrated embodiment of FIGS. 4 and 5, or by altering the formulations (e.g., the fiber blends) used in the outer layers 16 and 18 and/or the fibrous reinforcing core structure 10.

Examples of applications for the invention include automotive load floors, recreational vehicle sidewalls and flooring systems, highway trailer sidewalls, aircraft interior partitions, interior housing wall systems, self-standing office panels, door inserts, shelf and shelf panel systems, and desktops and other work surfaces.

Certain specific embodiments are exemplified by the following illustrative examples, which are intended to facilitate a better understanding thereof, but which are not intended to in any way limit the scope of the invention as defined by the appending claims.

### Examples 1 and 2

Load floor deflection tests were performed on composite panels in accordance with the invention having a fibrous reinforcing core structure with a plurality of parallel alternating ridges and grooves, wherein walls of each of said plurality of ridges have a corrugated surface as shown in FIGS. 1-5, and with the fibrous reinforcing core structure adhesively joined on each of its opposite sides to a flat sheet or layer of fibrous material. Each of the flat layers bonded to the fibrous reinforcing core structure was made from a fibrous mass consisting of about 23.3% thermal set resin by weight and about 65.2% natural fiber by weight and 11.5% 15 denier polyester fiber having a combined weight of about 1200 grams per square meter at a thickness of about 1.5 millimeters. The fibrous reinforcing core structure was also prepared from a fibrous mat comprising about 65.2% natural fiber by weight, and 11.5% 15 denier polyester fiber by weight and 23.3% non cross linking resin, with a basis weight of about 1200 grams per square meter after being shaped into the final structure as shown in FIGS. 4 and 5, and having the dimensions and tolerances as described above with respect to FIGS. 4 and 5. The contacting upper or outer surfaces of the top 30 of ridges 12 and the outer or bottom surface of bottom 32 of grooves 14 were adhesively bonded to the outer flat layers.

Load floor deflection testing was performed using a standard 3 point load deflection procedure. Samples were tested using a screw driven load frame with load cell for applying force at a top surface of the composite panel, with the edges of the sample being supported on blocks spaced 10 inches apart. All samples were tested with the length direction of the ridges being perpendicular to the support blocks. The overall thickness of each of the samples was about 15 mm. Force was applied at the center of each of the samples using a 3 inch diameter flat surface mounted on the hydraulic ram.

The composite panels of Examples 1 and 2 were substantially identical except for the adhesive used for bonding the layers together. Forbo Everlock 2U-235-1N reactive urethane hot melt was used for Example 1. Jowat Vise-Tite Plus polyurethane was used for Example 2. The results of the load deflection tests are summarized in the following table.

| | | | Deflection @ |
|---|---|---|---|
| | Deflection @ 300 | Max Load Tested | Max Load |
| Example No. | lb (mm) | (lb) | (mm) |
| 1 | 3.78 | 945 | 15 |
| 2 | 2.01 | 1000 | 9.78 |

The above data indicates that the composite panels of this invention should achieve a repeatable non-failure load of approximately 700-1000 pounds at 10 millimeter maximum deflection. Further, it is expected that the composite panels of the invention should have repeatable deflection results of less than 4 millimeters at 500 pounds. The composite panels tested did not exhibit any appreciable permanent yield.

### Examples 3-7

Load deflection tests were performed on composite panels (Examples 3-7) in accordance with the invention having a fibrous reinforcing core structure with a plurality of parallel alternating ridges and grooves, wherein walls of each of said plurality of ridges have a corrugated surface as shown in FIGS. 1-5, and with the fibrous reinforcing core structure adhesively joined on each of its opposite sides to a flat sheet or layer of fibrous material. Each of the flat layers bonded to the fibrous reinforcing core structure was made from a fibrous mass consisting of about 50% polypropylene by weight and about 50% natural fiber by weight and having a basis weight of about 1800 grams per square meter at a thickness of about 2.2 millimeters. The fibrous reinforcing core structure was also prepared from a fibrous mat comprising about 50% polypropylene and about 50% natural fibers, with a basis weight of about 1200 grams per square meter after being shaped into the final structure as shown in FIGS. 4 and 5, and having the dimensions and tolerances as described above with respect to FIGS. 4 and 5. The contacting upper or outer surfaces of the top 30 of ridges 12 and the outer or bottom surface of bottom 32 of grooves 14 were adhesively bonded to the outer flat layers.

Load deflection testing was performed using a standard 3 point load deflection procedure. Samples were tested using a screw driven load frame with load cell for applying force at a top surface of the composite panel, with the edges of the sample being supported on blocks spaced 10 inches apart. All samples were tested with the length direction of the ridges being perpendicular to the support blocks. The overall thickness of each of the samples was about 1 inch. Force was applied at the center of each of the samples using a 3 inch diameter flat surface mounted on the load cell.

Five (5) examples were tested. Each of the composite panels of Examples 3-7 was substantially identical except for the adhesive used for bonding the layers together. Elmer's® glue was used for bonding together the layers of Example 3. Gorilla® adhesive was used for bonding the layers together of Example 4. Bostik® H9483-CX5 was used to bond the layers together for the composite panel of Example 5. Bostik® 1211 contact cement was used to bond the layers together for the composite panel of Example 6. The layers of the composite panel of Example 7 were bonded together using Jowat Vise-Tite Plus Polyurethane glue.

The deflection at 300 pounds of load at the center of each of the composite panels was measured. For Example 5, the deflection at the maximum load tested (660 pounds) was determined, and for Example 6, the deflection at maximum load for the maximum load tested (545 pounds) was determined. The results of the load deflection testing are summarized in the following table.

| | | | Deflection @ |
|---|---|---|---|
| | Deflection @ 300 | Max Load Tested | Max Load |
| Example No. | lb (mm) | (lb) | (mm) |
| 3 | 1.68 | — | |
| 4 | 1.31 | — | |
| 5 | 2.68 | 660 | 7.66 |
| 6 | 2.97 | 545 | 6.20 |
| 7 | 1.47 | 1000 | 12.7 |

Neither the composite panel of Example 3 nor the composite panel of Example 4 demonstrated any detectable bond failure or creeping. The increase in deflection of the panel of Example 5 (at 300 pounds) as compared with the composite panels of Examples 3 and 4 is believed to be attributable to adhesive shearing at the bond line. The composite panel of Example 6 exhibited similar bond shearing during testing.

The above data indicates that the composite panels of this invention should achieve a repeatable non-failure load of approximately 700-1000 pounds at 10 millimeter maximum deflection. Further, it is expected that the composite panels of the invention should have repeatable deflection results of less than 4 millimeters at 500 pounds. The composite panels tested did not exhibit any appreciable permanent yield.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention.

The invention claimed is:

1. A reinforcing core structure for a composite panel, comprising:
a body having a plurality of generally parallel, alternating ridges and grooves, wherein walls of each of said plurality of ridges have a corrugated surface.

2. The reinforcing core structure of claim 1, which is shaped from a fibrous body comprising a combination of natural fibers and a thermoplastic or thermosettable resin.

3. The reinforcing claim structure of claim 1, which is formed of a fibrous body impregnated with a thermosettable resin in an amount of from about 10% to about 40% of the weight of the fibrous body.

4. The reinforcing core structure of claim 1, which is shaped from a fibrous body comprising from about 30% to about 70% of at least one natural fiber by weight, and from about 30% to about 70% binder material by weight.

5. The fibrous reinforcing core structure of claim 4, wherein the binder material is comprised of thermoplastic fibers.

6. The fibrous reinforcing core structure of claim 4, wherein the thermoplastic fibers are polypropylene fibers.

7. The fibrous reinforcing core structure of claim 1, which is shaped from a fibrous body consisting of from 50% to 100% natural fibers, and the balance being fibers selected from synthetic fibers, metal fibers, glass fibers, and carbon fibers; and a thermosettable binder in an amount of 10% to 40% of the weight of the fibrous body.

8. A composite panel comprising:
a reinforcing core structure having a plurality of generally parallel alternating ridges and grooves, wherein walls of each of said plurality of ridges have a corrugated surface;
a first layer of material joined to a first side of the reinforcing core structure; and
a second layer of material joined to a second side of the reinforcing core structure.

9. The composite panel of claim 8, in which the reinforcing layer is shaped from a fibrous body comprising a combination of natural fibers and a thermoplastic or thermosettable resin.

10. The composite panel of claim 8, which is formed of a fibrous body impregnated with a thermosettable resin in an amount of from about 10% to about 40% of the weight of the fibrous body.

11. The composite panel of claim 8, in which the reinforcing layer is shaped from a fibrous body comprising from about 30% to about 70% of at least one natural fiber by weight, and from about 30% to about 70% binder material by weight.

12. The composite panel of claim 11, wherein the binder material is comprised of thermoplastic fibers.

13. The composite panel of claim 11, wherein the thermoplastic fibers are polypropylene fibers.

14. The composite panel of claim 8, which is shaped from a fibrous body consisting of from 50% to 100% natural fibers, and the balance being fibers selected from synthetic fibers, metal fibers, glass fibers, and carbon fibers; and a thermosettable binder in an amount of 10% to 40% of the weight of the fibrous body.

15. The composite panel of claim 8, in which the first and second layers are joined to the fibrous reinforcing core structure with an adhesive.

16. The composite panel of claim 8, wherein the first and second layers are joined to the fibrous reinforcing core structure by a thermofusion joint.

17. The composite panel of claim 8, wherein the fibrous reinforcing core structure has a basis weight of about 1500 to about 2500 grams per square meter, and each of the first and second layers has a basis weight of from about 1000 to about 1500 grams per square meter.
